(19) United States
(12) Patent Application Publication
(10) Pub. No.: US 2012/0131584 A1
(43) Pub. Date: May 24, 2012

(54) Devices and Methods for Optimizing Data-Parallel Processing in Multi-Core Computing Systems

(76) Inventor: Alexey Raevsky, Moscow (RU)

(21) Appl. No.: 13/145,618

(22) PCT Filed: Feb. 16, 2010
(86) PCT No.: PCT/IB2010/000412

§ 371 Date: Feb. 6, 2012

Related U.S. Application Data
(60) Provisional application No. 61/152,482, filed on Feb. 13, 2009.

(51) Int. Cl. G06F 9/46

(52) U.S. Cl. 718/102

(57) ABSTRACT

According to an embodiment of a method of the invention, at least a portion of data to be processed is loaded to a buffer memory of capacity (B). The buffer memory is accessible to N processing units of a computing system. The processing task is divided into processing threads. An optimal number (n) of processing threads is determined by an optimizing unit of the computing system. The n processing threads are allocated to the processing task and executed by at least one of the N processing units. After processing by at least one of N processing units, the processed data is stored on a disk defined by disk sectors, each disk sector having storage capacity (S). The storage capacity (B) of the buffer memory is optimized to be a multiple X of sector storage capacity (S). The optimal number (n) is determined based, at least in part on N, B and S. The system and method are implementable in a multithreaded, multi-processor computing system. The stored encrypted data may be later recalled and decrypting using the same system and method.

### CROSS REFERENCE TO RELATED APPLICATIONS

This application claims priority to provisional application Ser. No. 61/152,482 filed Feb. 13, 2009 the specification of which is incorporated herein by reference in its entirety.

### FIELD OF THE INVENTION

The present invention relates generally to methods and systems for parallel processing in multi-core computing systems and more particularly to systems and methods for data-parallel processing in multi-core computing systems.

### BACKGROUND OF THE INVENTION

The simultaneous use of more than one CPU or core’ to execute a program or multiple computational steps is known as parallel processing. Ideally, parallel processing makes a program run faster because there are more cores running the program. There are two main techniques for decomposing a sequential program into parallel programs: (1) functional decomposition, or ‘program parallel’ decomposition, and (2) data decomposition, or ‘data parallel’ decomposition. A program parallel technique identifies independent and functionally different tasks comprising a given program. Functionally distinct threads are then executed concurrently using a plurality of cores. The term ‘thread’ refers to a sequence of process steps which carry out a task, or portion of a task.

A data parallel approach executes the same functional task on a plurality of processors. Each processor performs the same task on a different subset of a larger data set. Thus a system comprising 10 processors might be expected to process a given data set ten times faster than a system comprising 1 processor carrying out the same functional task repeatedly for multiple subsets of the data set. However, in practice such increases in processing time are difficult to achieve. A processing bottleneck may occur if one of the 10 processors is occupied with a previous task at the time execution of the data parallel task is initiated. In that case, processing the entire dataset by all 10 processors could not be completed at least until the last processor had finished its previous task. This processing delay can negate the benefits associated with parallel processing.

Therefore, there is a need for systems and methods for optimizing data-parallel processing in multi-core computing systems.

### SUMMARY OF THE INVENTION

According to an embodiment of a method of the invention, at least a portion of data to be processed is loaded to a buffer memory of capacity (B). The buffer memory is accessible to N processing units. The processing task is divided into processing threads. An optimal number (n) of processing threads is determined by an optimizing unit. The n processing threads are allocated to the processing task and executed by at least one of the N processing units. After processing by at least one of N processing units, the processed (encrypted) data is stored on a disk

### DESCRIPTION OF THE DRAWING FIGURES

These and other objects, features and advantages of the invention will be apparent from a consideration of the following detailed description of the invention considered in conjunction with the drawing figures, in which:

FIG. 1 is a block diagram illustrating a conventional functional decomposition technique;

FIG. 2 is a block diagram illustrating a conventional data decomposition technique;

FIG. 3 is a block diagram of a data parallel processing optimizing device implemented in a bus organized computing system in accordance with an embodiment of the invention;

FIG. 4 is a functional block diagram illustrating a device for optimizing data parallel processing in a multi CPU computer system in a computing system according to an embodiment of the invention;

FIG. 5 is a flow chart illustrating steps of a method for optimizing data parallel processing in a multi CPU computer system according to an embodiment of the invention;

FIG. 6 illustrates completion of execution of threads according to a technique employed in an embodiment of the invention;

FIG. 7 illustrates completion of execution of threads according to a technique employed in an embodiment of the invention;

FIG. 8 is a flowchart illustrating steps in a method for data-parallel processing according to an embodiment of the invention.

### DETAILED DESCRIPTION OF THE INVENTION

In accordance with the present invention, there are provided herein methods and systems for optimizing data-parallel processing in multi-core computing systems.

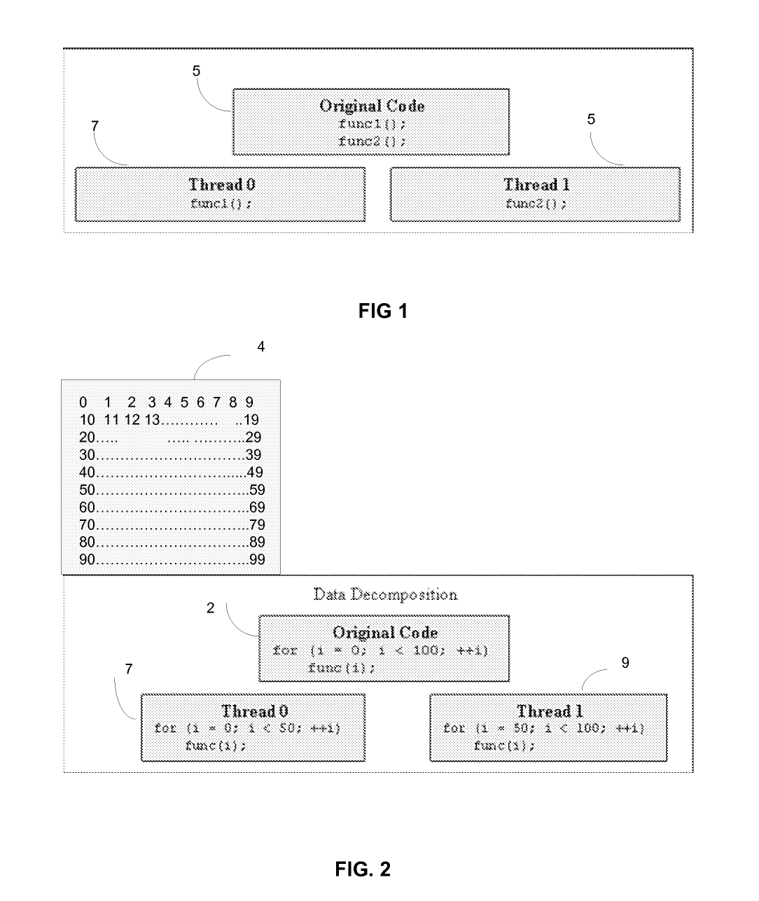

### FIG. 1

FIG. 1 is a block diagram illustrating concepts of a conventional function parallel decomposition technique. A computer program 5 comprises instructions, or code which, when executed, carry out the instructions. Program 5 implements two functions, ‘func1’ and ‘func2’. A first thread (Thread 0, indicated at 7) executes func 1. A second thread (Thread 1, indicated at 9) executes a different function, func2. Thread 0 and thread 1 may be executed on different processors at the same time.

### FIG. 2

FIG. 2 is a block diagram illustrating concepts of a conventional data-parallel decomposition technique suitable for implementing various embodiments of the invention. A computer program 2 comprises instructions, or code which, when executed, carry out the instructions with respect to a data set 4. Example data set 4 comprises 100 values, i₀ to i₉₉. It will be understood data set 4 is a simplified example of a data set. The invention is suitable for use with a wide variety of data sets as explained in more detail below.

Program 2 implements a function, ‘func’ to be carried out with respect to data set 4. A first thread (Thread 0) applies function (func) to a first subset (i=0 to i<50) of data set 4. A second thread (Thread 1) applies the same function (func) to a second subset (I=50 to i<100 of data set 4. Threads 1 and 2 execute the same instructions. Threads 1 and 2 may execute their respective instructions in parallel, i.e., at the same time. However, the instructions are carried out on different subsets of data set 4.

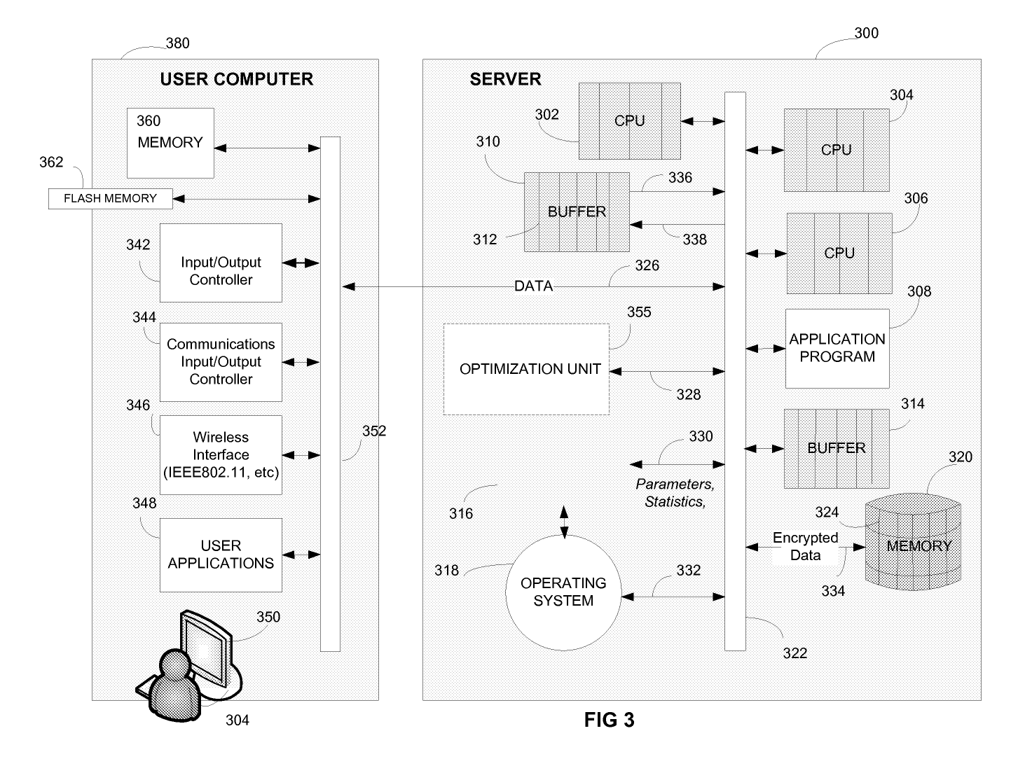

### FIG. 3

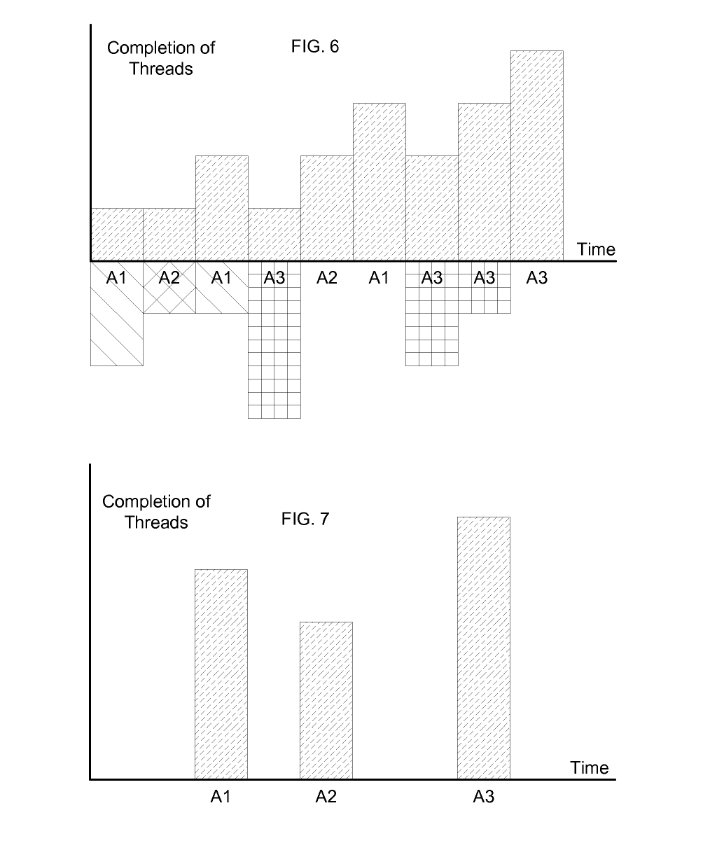

FIG. 3 is a block diagram of a data parallel processing optimizing device implemented in a bus organized computing system 300 in accordance with an embodiment of the invention. According to the embodiment illustrated in FIG. 3, an optimizing device of the invention is implemented in a server system. In this embodiment a user computer system processes user applications to generate data 126. Data 126 is provided to server 100 for further processing and storage in a memory 120 of system 100. The embodiment of FIG. 6 illustrates a user computer system as a source of data for processing by an application program 108. However, it will be understood that a wide variety of sources of data, both external to computing system 100, and within computing system 100, can generate data to be processed in accordance with the principles of the present invention.

### CPUs 302, 304, 306

Computing system 300 comprises a multiprocessor computing system, including at least two CPUs. For purposes of illustration three CPUs 302, 304 and 306, are illustrated in FIG. 3. It will be understood that three CPUs are illustrated in FIG. 3 for ease of discussion. However, the invention is not limited with respect to any particular number of CPUs.

In general, a CPU is a device configured to perform an operation upon one or more operands (data) to produce a result. The operation is performed in response to an instruction executed by the CPU. Multiple CPUs enable multiple threads to execute simultaneously, with different threads of the same process running on each processor. In some configurations, a particular computing task may be performed by one CPU while other CPUs perform unrelated computing tasks. Alternatively, components of a particular computing task may be distributed among multiple CPUs to decrease the time required to perform the computing task as a whole. One embodiment of the invention implements a symmetric multiprocessing (SMP) architecture. According to this architecture any process can run on any available processor. The threads of a single process can run on different processors at the same time.

### Application Program 308

Computer system 300 is configured to execute at least one application program 308 to process incoming data 326. An application program comprises instructions for execution by at least one of CPUs 302, 304 and 306. According to one embodiment of the invention, application program 308 is data-parallel decomposed to generate at least a first and a second thread. As described above with reference to FIG. 2, the first and second threads perform the same function. The first thread carries out the function over a first subset of the data set stored in first buffer 310. The second thread carries out the function over a second subset of the data set stored in first buffer 310. In that manner data comprising data set 310 is parallel processed to provide a processed data set. The processed data set is stored in a second buffer 314.

In one embodiment of the invention application program 308 comprises a data encryption program. In that embodiment incoming data 326 comprises data to be encrypted. However, the invention is applicable to other types of application programs as will be discussed further below.

### First and Second Buffers 310 and 314

Microprocessors in their execution of software strings typically operate on data that is stored in memory. This data needs to be brought into the memory before the processing is done, and sometimes needs to be sent out to a device that needs it after its processing. Incoming data 126 is stored in a first buffer 310. Data stored in buffer 310 are accessible to at least one of CPUs 302. 304 and 306 during execution of application program 308. Execution of application program 308 is carried out under control of an operating system 332. During execution of program 308, processed data from first buffer 310 is stored in a second buffer 314. After program execution, data in second buffer 314 is written to memory 320.

In some embodiments of the invention at least one of first and second buffers 310- and 314 comprises cache memory. Cache memory typically comprises high-speed static Random Access Memory (SRAM) devices. Cache memory is used for holding instructions and/or data that are likely to be accessed in the near term by CPUs 302, 304 and 306.

If data stored in cache is required again, a CPU can access the cache for the instruction/data rather than having to access the relatively slower DRAM. Since the cache memory is organized more efficiently, the time to find and retrieve information is reduced and the CPU is not left waiting for more information.

Some embodiments of the invention are implanted using two types of cache memory, level 1 and level 2. Level 1 (L1) cache has a very fast access time, and is embedded as part of the processor device itself. Level 2 (L2) is typically situated near, but separate from, the CPUs. L2 cache has an interconnecting bus to the CPUs. Some embodiments of the invention comprise both L1 and L2 caches integrated into a chip along with a plurality of CPUs. Some embodiments of the invention employ a separate instruction cache and data cache.

### Memory 320

After a block of data is processed, the data stored in second buffer 314 is written to memory 320. In some embodiments of the invention memory 320 comprises a conventional hard disk. Conventional hard disks comprise at least two platters. Each platter comprises tracks, and sectors within each track. A sector is the smallest physical storage unit on a disk. The data size of a sector is a power of two. In most cases a sector comprises 512 bytes of data.

Other suitable devices for implementing memory 320 include IDE and SCSI hard drives, RAID mirrored drives, CD/DVD optical disks and magnetic tapes.

### Operating System 318

Operating system 318 “OS” after being initially loaded into the computing system 300, manages execution of all other programs. For purposes of this specification, other programs comprising computing system 300 are referred to herein as applications. Applications make use of operating system 318 by making requests for services through a defined application program interface (API).

Operating system 318 performs a variety of services for applications on computing system 300. Examples of services include handling input and output to and from disk 320. In addition OS 318 determines which applications should run in what order and how much time should be allowed for each application. OS 318 also manages the sharing of internal memory among multiple applications.

A variety of commercially available operating systems are available and suitable for implementing operating system 318. For example, Microsoft Windows NT-based operating systems such as Windows 2000 Server, Windows 2003 Server, and Windows 2008 Server, Windows 2000/XP/2003/2008 (32- and 64-bit), and Linux kernel 2.6.x. are suitable for implementing various embodiments of the invention.

### Optimizing Unit 314

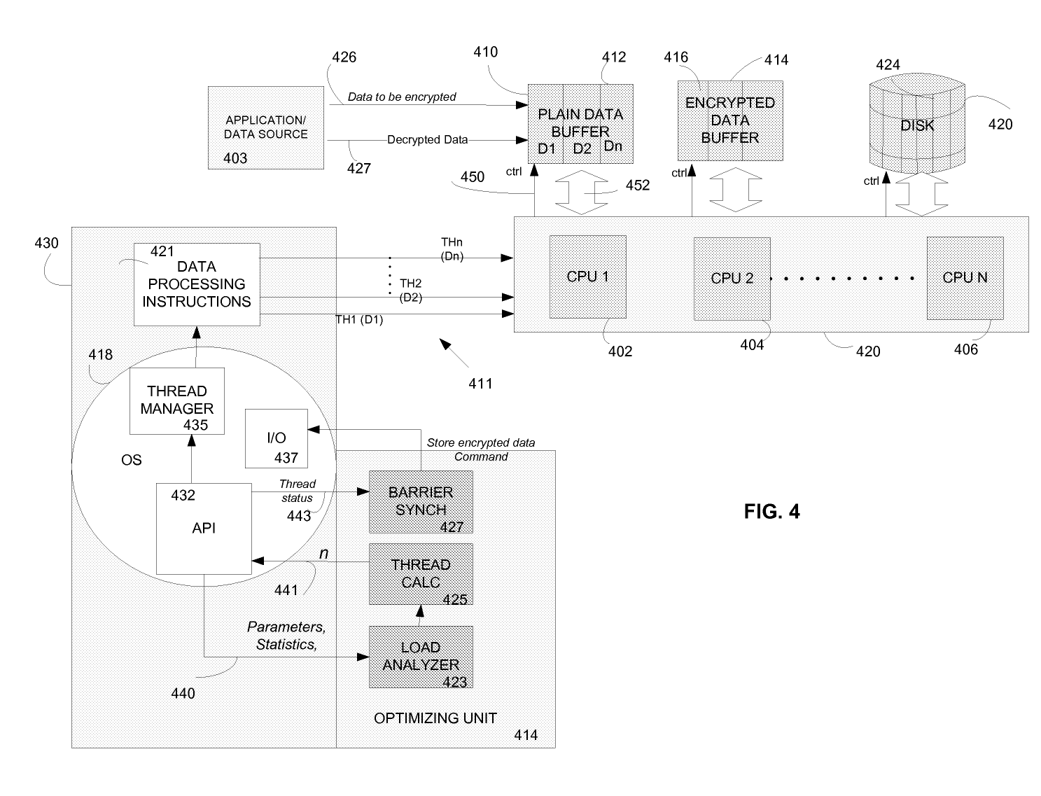

Optimizing unit 314 determines an optimal number of threads (n) for data-parallel processing by a plurality of CPUs of system 300. The determination is made to account for interrelationship of factors potentially affecting system performance when system 300 processes data-parallel threads for a task. Such factors include, but are not limited to number and availability of CPUs comprising system 300, type of program comprising data-parallel threads and size of first or second buffers 310 (for processing data to be stored to disk 320) or 314 (for processing data read from disk 320) in relation to the sector size of a final data storage device such as disk 320. Further details of optimizing unit e14 according to embodiments of the invention are provided below with reference to drawing FIG. 4.

Optimizing unit 314 receives system performance information from OS 318. Optimizing unit 314 determines an optimal number of threads (n) to be generated for efficient processing of data stored in first buffer 310 (when encrypting data) or second buffer 314 (when decrypting data). The determination is made based, at least in part, on the system performance information. In some embodiments of the invention, the determination of optimal number of threads (n) is made based, at least in part, on information related to relative storage capacities of buffers 310 relative to data block size processed by data parallel threads, and also relative to the sector size of disk 320.

Optimizing unit 355 determines n and provides an indication of n to OS 418. In response, OS 418 generates n threads for processing data stored in buffer 310 (or 314). OS 318 also schedules the generated threads for execution by at least one of CPUs 302, 304, 306. In one embodiment of the invention system 300 implements preemptive multitasking Operating system 318 schedules the n threads for execution by CPUs 302, 304 and 306 by assigning a priority to each of the n threads. If threads other than the threads generated by OS 318 to effect data-parallel processing of data in buffer 310 (or 314) are in process, operating system 318 interrupts (preempts) threads of lower priority by assigning a higher priority to each of the n threads associated with the data parallel task to be executed. In that case, execution of lower priority threads is preempted in favor of the higher-priority threads associated with the data-parallel task.

In one embodiment of the invention OS 318 implements at least one of a Round Robin (RR) thread scheduling algorithm, or a “First Come First Served” (FCFS) scheduling algorithm for scheduling processing of threads in a data parallel task. In one approach, OS 318 effects selection by assigning either a PASSIVE LEVEL IRQL or a DISPATCH-LEVEL IRQL to threads of the data parallel task.

Using that approach threads with PASSIVE LEVEL are scheduled for processing by the cyclic dispatch “Round Robin” (RR) algorithm, while “First Come First Served” (FCFS) dispatch algorithm is applied to threads with higher DISPATCH LEVEL IRQL.

In addition to scheduling based on priority assigned to threads, one embodiment of system 300 allocates a fixed period of time (or slice) to concurrently handle equally prioritized lower IRQL threads. Thus, each scheduled thread utilizing the exemplary RR procedure receives a single CPU slice at a time. At the end of each time slice processing can be interrupted and switched to another thread with same priority (as shown in the example of FIG. 6). For threads scheduled based on an FCFS approach, processing is not interruptible until processing of the existing threads is fully completed (as shown in the example of FIG. 7).

### Encryption Example

One embodiment of the invention implements an encryption algorithm as task. The encryption algorithm operates on a data set to be encrypted and writes the encrypted data to a storage media device such as hard drive 320. The encrypted stored data is decrypted upon data read-back. For example, first buffer 310 is loaded with a data set to be encrypted. According to one embodiment of the invention the data set comprises a whole number multiple of blocks of data to be encrypted.

Optimizing unit 314 evaluates the load levels of the system based on information it receives from OS 318. Optimizing unit 314 determines an optimal number (n) of CPUs to complete the required cryptography task. Subsets of the data set are assigned for data-parallel processing by the encryption task. Each subset comprises one of n equal portions of the data set. OS 318 generates a thread for processing each of the n subsets. Upon the completion of all n threads, the processed data is written to hard drive 320. According to one embodiment of the invention, the encryption algorithm executes in data-parallel mode in real-time as a background process of system 300.

### FIG. 4

FIG. 4 is a functional block diagram illustrating a device for optimizing data parallel processing in a multi CPU computer system implemented in a computing system 400 according to an embodiment of the invention. Computing system 400 comprises CPUs 420, data buffers 412, 414, hard disk 420 and operating system 430. CPUs 420 include example CPU1 indicated at 402, example CPU 2 indicated at 404 and example CPU N indicated at 406. In one embodiment of the invention, the plurality of CPUs is implemented on a single integrated circuit chip 420. Other embodiments comprise a plurality of CPUs implemented separately, or in combinations of on-chip and separate CPUs.

Operating system 430 includes, among other things, a thread manager 435, at least one application program interface (API) 432 and an input/output unit (I/O) 437. An optimizing unit 414 is coupled for communication with operating system 430. A set of data processing instructions comprises a task 421. In one embodiment of the invention, task 421 implements an encryption algorithm. A source of data 403 to be processed by the data processing instructions is coupled to a first data buffer 410.

### Operating System 418

Thread Manager 235

Parallel data processing systems and methods according to the various embodiments of the invention comprise a plurality of threads that concurrently execute the same program on different portions of an input data set stored in first buffer 412. Each thread has a unique identifier (thread ID) that can be assigned at thread launch time and that controls various aspects of the thread's processing behavior, such as the portion of the input data set to be processed by each thread, the portion of the output data set to be produced by each thread, and/or sharing of intermediate results among threads.

Operating system 418 manages thread generation and processing so that a program runs on more than one CPU at a time. Operating system 418 schedules threads for execution by CPUs 402, 404 and 406. Operating system 418, also handles interrupts and exceptions.

In one embodiment of the invention, operating system 418 schedules ready threads for processor time based upon their dynamic priority, a number from 1 to 31 which represents the importance of the task. The highest priority thread always runs on the processor, even if this requires that a lower-priority thread be interrupted.

In one embodiment of the invention operating system 418 continually adjusts the dynamic priority of threads within the range established by a base priority. This helps to optimize the system's response to users and to balance the needs of system services and other lower priority processes to run, however briefly.

System Performance Monitoring

Operating system 418 is capable of monitoring statistics related to processes and threads executing on the CPUs of system 400. For example, the Windows NT 4 operating system implements a variety of counters which monitor and indicate activity of CPUs comprising system 400.

TABLE 1
OPERATING SYSTEM COUNTERS

| Counter | Description |
|---|---|
| System: % | For what proportion of the sample interval were all processors busy? |
| Total Processor | A measure of activity on all processors. In a multiprocessor computer, this is equal |
| Time | to the sum of Processor: % Processor Time on all processors divided by the |
| | number of processors. On single-processor computers, it is equal to Processor: % |
| | Processor time, although the values may vary due to different sampling time. |
| System: | How many threads are ready, but have to wait for a processor? |
| Processor | |
| Queue Length | |
| Processor: % | For what proportion of the sample interval was each processor busy? |
| Processor Time | This counter measures the percentage of time the thread of the Idle process is |
| | running, subtracts it from 100%, and displays the difference. |
| Processor: % | How often were all processors executing threads running in user mode and in |
| User Time | privileged mode? |
| Processor: % | |
| Privileged Time | |
| Process: % | For what proportion of the sample interval was the processor running the threads |
| Processor Time | of this process? |
| Process: % | For what proportion of the sample interval was the processor processing? |
| Processor | This counter sums the time all threads are running on the processor, including the |
| Time: _Total | thread of the Idle process on each processor, which runs to occupy the processor |
| | when no other threads are scheduled. |
| | The value of Process: % Processor Time: _Total is 100% except when the |
| | processor is interrupted. (100% processor time = Process: % Processor Time: |
| | Total + Processor: % Interrupt Time + Processor: % DPC Time) This counter |
| | differs significantly from Processor: % Processor Time, which excludes Idle. |
| Process: % | How often are the threads of the process running in its own application code (or |
| User Time | the code of another user-mode process)? How often are the threads of the process |
| Process: % | running in operating system code? |
| Privileged Time | Process: % User Time and Process: % Privileged Time sum to Process: % |
| | Processor Time. |
| Process: | What is the base priority of the process? How likely is it that this process will be |
| Priority Base | able to execute if the processor gets busy? |
| Thread: Thread | What is the processor status of this thread? |
| State | An instantaneous indicator of the dispatcher thread state, which represents the |
| | current status of the thread with regard to the processor. Threads in the Ready |
| | state (1) are in the processor queue. |
| Thread: Priority | What is the base priority of the thread? |
| Base | The base priority of a thread is determined by the base priority of the process in |
| | which it runs. |
| Thread: Priority | What is the current dynamic priority of this thread? How likely is it that the thread |
| Current | will get processor time? |
| Thread: % | How often are the threads in the process running in their own application code (or |
| Privileged ) Time | the code of another user-mode process)? How often are the threads of the process |
| | running in operating system code? |
| | Process: % User Time and Process: % Privileged Time sum to Proces : % |
| | Processor Time. |

### Optimizer 414

For purpose of an exemplary embodiments of the analysis using the exemplary system, process and computer accessible medium according to the present invention, it can be assumed that it can take a whole number of CPU slices to complete processing of any thread within the exemplary system, irrelevant of the interruption algorithm or procedure being applied or utilized. For example, N can be the number of processors, n may be a number of concurrent threads created, and T can be a number of CPU time slices to complete the whole processing with a single processor.

Load Analyzer 423

In one embodiment of the invention a CPU-equivalent capacity is determined by load analyzer 423. For example, an average CPU-equivalent capacity available is determined analytically. In other embodiments, load analyzer 423 employs predictive methods of imitational modeling and/or statistical analysis. Examples of suitable analysis include: Predicting CPUs load levels using time series; Analytically deriving the relationship between the system's work load parameters (scheduled threads quantities and their IRQL levels, frequencies of incoming hardware interruptions, etc.) and the CPUs loads; Empirically determining the relationship using methods of imitational modeling to calculate amount of free CPU resources at any given time; Empirically determining the relationship by gathering the system's statistics to calculate amount of free CPU resources at any given time. In one embodiment of the invention, (n) represents an average CPU available capacity expressed as number of available CPUs. According to one embodiment of the invention, the number of available CPUs is provided to thread calculator 412 to be accounted for when determining the number of threads to generate for data parallel execution of a processing task.

Thread Calculator 425

In one embodiment of the invention a thread calculator 425 determines an optimal number of threads for data-parallel processing of data in first data buffer 410. The determination depends on the scheduling algorithm employed by operating system 418 in scheduling execution of the parallel threads by CPUs. When a round-robin algorithm is employed, the number of threads is determined by the number of data subsets comprising first buffer 410, wherein each data subset is defined to comprise one block of data. For example, in the case where first buffer 410 stores a data set comprising 16 Kbytes, and a block is 512 bytes of data, a number of threads is 16 KB/512 B=32 threads. Each thread will process one of 32 subsets of data stored in first buffer 410.

When a FCFS algorithm is employed, optimizing unit 414 determines the number of threads by obtaining and analyzing system parameters from operating system 418 according to one embodiment of the invention. In one embodiment of the invention the number of threads is determined based on the indication of number of available CPUs provided by load analyzer 423.

Table II describes parameters are provided by operating system 418 to optimizer 414 according to one embodiment of the invention.

TABLE II

| Parameter | Description |
|---|---|
| P_{high} | Percentage of CPU time while processing |
| | high-priority threads. High priority threads |
| | are threads with priority higher than the |
| | priority of the n threads. For example, on |
| | Windows NT-based systems this parameter |
| | is a sum of interrupt time percentage and |
| | DPC time percentage. |
| P_{low} | Percentage of CPU time consumed during |
| | processing low-priority threads. This |
| | means priority equal to the priority |
| | assigned to n threads. For example, on |
| | Windows NT-based systems this parameter |
| | is 100% minus idle time minus P_{high} |
| Q_{high} | average number of high priority threads |
| Q_{low} | average number of low priority threads |

Optimizing unit 414 requests each of the parameters in table II periodically. For example, every X seconds. Optimizing unit 414 averages successive respective values of each of the parameters over a period Y seconds of time. Values X and Y are set by system administrator and are adjustable to accommodate changes in system 400 workload. For example X may be 0.1 seconds and Y may be 5 minutes.

To determine an optimal number of threads (n), thread calculator 425 first calculates a time Tₚₐᵣ for executing threads in parallel for a plurality of test values for n. In one embodiment of the invention Tₚₐᵣ is related to n as follows:

$${T}_{par} = \{ \begin{matrix}{T}_{free} + \frac{T}{n} & when n \leq N - {E}_{1} \\ {T}_{free} + \frac{( k + 1 ) T}{n} & when k ( N - {E}_{1} ) < n \leq ( k + 1 ) ( N - {E}_{1} ) , k ∈ •\end{matrix}$$

Wherein N denotes the total number of CPUs comprising system 400 and T denotes time required for processing the input data set stored in first buffer 410 by a single thread, i.e., without parallelization. T is by dividing the size of the data set stored in first buffer 410 by the processing speed of a single CPU of system 400. Processing speed is a constant for given CPU type. According to one embodiment of the invention processing speed is defined empirically, for example during system setup by processing a fixed memory block of known size and measuring time of this operation. The measured time is used as the value of T.

Wherein T_{free} is defined as follows:

$${T}_{free} = \{ \begin{matrix}0 , & when {E}_{0} \leq N - {E}_{1} - n \\ M , & when N - {E}_{1} - n < {E}_{0} \leq N - {E}_{1} \\ ( k + 1 ) M , & when k ( N - {E}_{1} ) < {E}_{0} \leq ( k + 1 ) ( N - {E}_{1} ) , \{ \frac{{E}_{0}}{N - {E}_{1}} \} \leq \{ \frac{N - {E}_{1} - n}{N - {E}_{1}} \} , k ∈ • \\ ( k + 2 ) M , & when k ( N - {E}_{1} ) < {E}_{0} ( k + 1 ) ( N - {E}_{1} ) , \{ \frac{{E}_{0}}{N - {E}_{1}} \} > \{ \frac{N - {E}_{1} - n}{N - {E}_{1}} \} , k ∈ •\end{matrix} )$$

Wherein:

$${E}_{0} = {Q}_{low} ;$$

$$M = \frac{Y}{{Q}_{low}} \frac{{P}_{low}}{100 \%} ;$$

$${E}_{1} = \frac{{NP}_{high}}{100 \%} ;$$

Optimizer 414 determines Tₚₐᵣ for each n from 1 to N based on the above relationships. Optimizer 414 choosing n such that Tₚₐᵣ is minimized.

Barrier Synchronizer

Barrier Synchronization can mean, but in no way limited to a method of providing synchronization of processes in a multiprocessor system by establishing a stop (“wait”) point

Threads typically execute asynchronously with respect to each other. That is to say, the operating environment does not usually enforce a completion order on executing threads, so that threads normally cannot depend on the state of operation or completion of any other thread. One of the challenges in data-parallel processing is to ensure that threads can be synchronized when necessary. For example, array and matrix operations are used in a variety of applications such as graphics processing. Matrix operations can be efficiently implemented by a plurality of threads where each thread handles a portion of the matrix. However, the threads must stop and wait for each other frequently so that faster threads do not begin processing subsequent iterations before slower threads have completed computing the values that will be used as inputs for later operations.

Barriers are constructs that serve as synchronization points for groups of threads that must wait for each other. A barrier is often used in iterative processes such as manipulating an array or matrix to ensure that all threads have completed a current round of an iterative process before being released to perform a subsequent round. The barrier provides a “meeting point” for the threads so that they synchronize at a particular point, such as the beginning or end of an iteration. An iteration is referred to as a “generation”. A barrier is defined for a given number of member threads, sometimes referred to as a thread group. This number of threads in a group is typically fixed upon construction of the barrier. In essence, a barrier is an object placed in the execution path of a group of threads that must be synchronized. The barrier halts execution of each of the threads until all threads have reached the barrier. The barrier determines when all of the necessary threads are waiting (i.e., all threads have reached the barrier), then notifies the waiting threads to continue.

A conventional barrier is implemented using a mutual exclusion (“mutex”) lock, a condition variable (“cv”), and variables to implement a counter, a limit value and a generation value. When the barrier is initialized for a group of threads of number “N”, the limit and counter values are initialized to N, while the variable holding the generation value is initialized to zero. The limit variable represents the total number of threads while the counter value represents the number of threads that have previously reached the waiting point.

A thread “enters” the barrier and acquires the barrier lock. Each time a thread reaches the barrier, it checks to see how many other threads have previously arrived by examining the counter value, and determines whether it is the last to arrive thread by comparing the counter value to the limit. Each thread that determines it is not the last to arrive (i.e., the counter value is greater than one), will decrement the counter and then execute a “cond_wait” instruction to place the thread in a sleep state. Each waiting thread releases the lock and waits in an essentially dormant state.

Essentially, the waiting threads remain dormant until signaled by the last thread to enter the barrier. In some environments, threads may spontaneously awake before receiving a signal from the last to arrive thread. In such a case the spontaneously awaking thread must not behave as or be confused with a newly arriving thread. Specifically, it cannot test the barrier by checking and decrementing the counter value.

One mechanism for handling this is to cause each waiting thread to copy the current value of the generation variable into a thread-specific variable called, for example, “mygeneration”. For all threads except the last thread to enter the barrier, the mygeneration variable will represent the current value of the barrier's generation variable (e.g., zero in the specific example). While its mygeneration variable remains equal to the barrier's generation variable the thread will continue to wait. The last to arrive thread will change the barrier's generation variable value. In this manner, a waiting thread can spontaneously awake, test the generation variable, and return to the cond_wait state without altering barrier data structures or function.

When the last to arrive thread enters the barrier the counter value will be equal to one. The last to arrive thread signals the waiting thread using, for example, a cond_broadcast instruction which signals all of the waiting threads to resume. It is this nearly simultaneous awakening that leads to the contention as the barrier is released. The last to arrive thread may also execute instructions to prepare the barrier for the next iteration, for example by incrementing the generation variable and resetting the counter value to equal the limit variable.

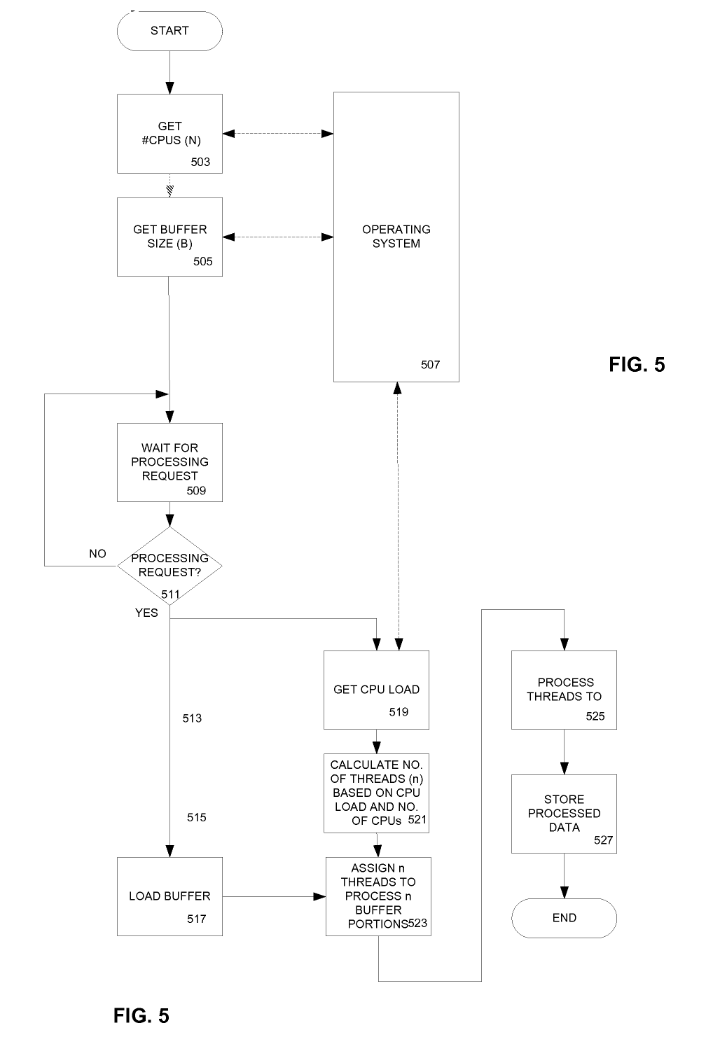

### FIG. 5

FIG. 5 is a flow chart illustrating steps of a method for optimizing data parallel processing in a multi CPU computer system according to an embodiment of the invention. At 503 the number (N) of CPUs comprising system 400 (FIG. 4) is determined. At 505, storage capacity B of the input data buffer 410 (or 414) is determined.

System 400 receives a processing request at 511. In response to receiving the processing request, system 400 loads input data to data buffer 410, at 517. System 400 determines CPU load at 519. At 521, system 400 determines an optimal number (n) of threads for processing data loaded into buffer 410. At 525 (n) threads are processed using a data-parallel technique. At 527 processed data is stored in second buffer 414. The processed data is then written to hard disk 420.

### FIG. 6

FIG. 6 illustrates a round robin scheduling technique employed by OS 418 to an embodiment of the invention.

### FIG. 7

FIG. 7 illustrates a first come first served scheduling technique employed by OS 418 according to an embodiment of the invention.

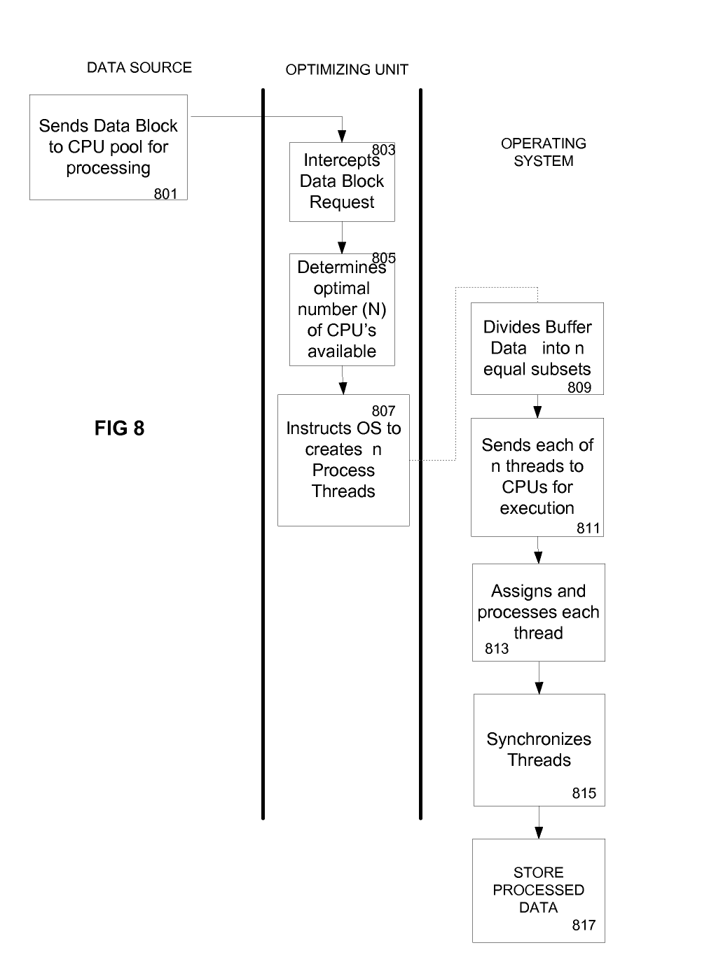

### FIG. 8

FIG. 8 is a flow diagram illustrating steps of a method for optimizing data-parallel processing in multi-core computing systems according to an embodiment of the invention. At 801 a data source provides a data set to be processed by system 400 (illustrated in FIG. 4). The data source further provides a request for processing the data comprising the data block. At 803 an optimizing unit of the invention intercepts the request. At 805 the optimizing unit determines an optimal number (n) of the total number of CPUs (N) comprising system 400. At 807 the optimizing unit instructs the operating system of system 400 to generate n threads for parallel processing of the data set.

At 809 system 400 associates each of the n threads with a corresponding subset of the data set. At 811 the OS of system 400 initiates processing of each of the n threads. In one embodiment of the invention, a barrier synchronization technique is employed at 811 to coordinate and synchronize the execution of each of the n threads. At 817 the processed data set is stored, for example, in a hard disk storage associated with system 400.

Thus there have been provided devices and methods for optimizing data-parallel processing in multi-core computing systems. It will thus be appreciated that those skilled in the art will be able to devise numerous systems, arrangements, computer-accessible medium and processes which, although not explicitly shown or described herein, embody the principles of the invention and are thus within the spirit and scope of the present invention. The exemplary embodiments of the computer accessible medium which can be used with the exemplary systems and processes can include, but not limited to, volatile memory such as random access memory (RAM), non-volatile memory such as read only memory (ROM) or flash memory storage, data storage devices such as magnetic disk storage (e.g., hard disk drive or HDD), tape storage, optical storage (e.g., compact disk or CD, digital versatile disk or DVD), or other machine-readable storage mediums that can be removable, non-removable, volatile or non-volatile. In addition, all publications, patents and patent applications referenced herein are incorporated herein by reference in their entireties.

What is claimed is:

1. In a system comprising a plurality of CPUs, a method for optimizing processing of input data associated with a system computing task, wherein processed input data is to be stored in a memory defined by a plurality of sectors of sector size (S), the method comprising:
providing a data buffer capable of storing (B) bytes of data, wherein B is a whole number multiple (M) of said sector size (S);
loading said data buffer with said input data up to B;
analyzing processing activity of said CPUs to determine an optimal number (n) of CPU process threads to associate with said loaded input data;
assigning each of said (n) process threads to a corresponding portion of said loaded data such that B bytes of said processed input data is stored in (M)*(S) sectors of said memory.

2. The method of claim 1 wherein the storing step is carried out only after execution of each of said process threads is completed.

3. The method of claim 1 wherein the step of analyzing CPU activity is carried out periodically.

4. The method of claim 3 including a step of receiving from a system operator, an indication of said time period for carrying out said analyzing step.

5. The method of claim 1 wherein the step of analyzing CPU activity is carried out including steps of:
analyzing system operating statistics;
determining n based at least in part, on the outcome of the analyzing step.

6. The method of claim 5 wherein the step of analyzing system operating statistics is carried out by analyzing at least one of task statistics, CPU statistics.

7. A unit for optimizing processing, by a system comprising a plurality of CPUs, input data associated with a system computing task, wherein processed input data is to be stored in a memory defined by a plurality of sectors of sector size (S), the method comprising:
a data buffer capable of storing (B) bytes of data, wherein B is a whole number multiple of said sector size (S);
a CPU load analyzer coupled to said CPUs to sense workload and analyzing processing activity of said CPUs to determine a number (n) representing CPU processing capacity;
a thread assignment unit configured to determine an optimal number (O) of process threads to associate with said loaded input data wherein (O) is determined based on (n), said unit assigning each of said O process threads to a corresponding portion of said loaded data;
receiving processed input data from at least one of said N CPUs upon execution of said process threads;
providing said processed input data to said memory for storage.
